(19) United States
(12) Patent Application Publication
(10) Pub. No.: US 2007/0084667 A1
(43) Pub. Date: Apr. 19, 2007

(54) Drag harness

(75) Inventors: Patricia K. Waters, Tipp City, OH (US); William L. Grilliot, Dayton, OH (US); Mary I. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(73) Assignee: Morning Pride Manufacturing, L.L.C.

(21) Appl. No.: 11/254,032

(22) Filed: Oct. 19, 2005

(51) Int. Cl. A62B 35/00

(52) U.S. Cl. 182/3

(57) ABSTRACT

A drag harness comprises an elongate, flexible member, which is connected end-to-end so as to define a large loop, and a drag grip, which is provided with a pair of tunnels. Through each of the tunnels, the elongate, flexible member passes so as to divide the large loop into two arm loops having the drag grip between the arm loops. The elongate, flexible member passes loosely therethrough, whereby relative sizes of the arm loops are variable.

### TECHNICAL FIELD OF THE INVENTION

This invention pertains to a drag harness of a type used by a rescuer, such as a firefighter, to drag a wearer from a perilous situation.

### BACKGROUND OF THE INVENTION

Drag harnesses of the type noted above are exemplified in United States Patent Application Publications No. US 2005/0173188 A1 and US 2005/0211188 A1, the disclosures of which are incorporated herein by reference. Drag harnesses of the type noted above also are exemplified in U.S. Pat. No. 4,682,671, No. 4,854,418, and No. 6,205,584 B1.

### SUMMARY OF THE INVENTION

This invention provides a drag harness comprising an elongate, flexible member defining a large loop, and further comprising a drag grip provided with tunnel means, through which the elongate, flexible member passes so as to divide the large loop into two arm loops having the drag grip between the arm loops. Preferably, the elongate, flexible member is connected end-to-end so as to define the large loop.

Preferably, the elongate, flexible member passes loosely through the tunnel-defining means, whereby relative sizes of the arm loops are variable. Preferably, the elongate, flexible member passes through each of a pair of tunnels so as to divide the large loop into the arm loops.

Herein, all references to tunnel means are intended to encompass any suitable means for defining a tunnel or tunnels, for defining a ring or rings, or for defining a loop or loops.

### BRIEF DESCRIPTION OF THE DRAWINGS

FIG. 1 is a fragmentary, pictorial view of a rescuer using a drag harness embodying this invention to drag a wearer, who is a firefighter, from a perilous situation.

FIGS. 2A and 2B are fragmentary, pictorial views, which are taken from a different vantage, behind a wearer of the drag harness, and which illustrate how relative sizes of two arm loops of the drag harness are variable.

FIG. 3 is a cross-sectional view, which is taken along line 3-3 of FIG. 2B, in a direction indicated by arrows, and which illustrates constructional details of a drag grip of the drag harness.

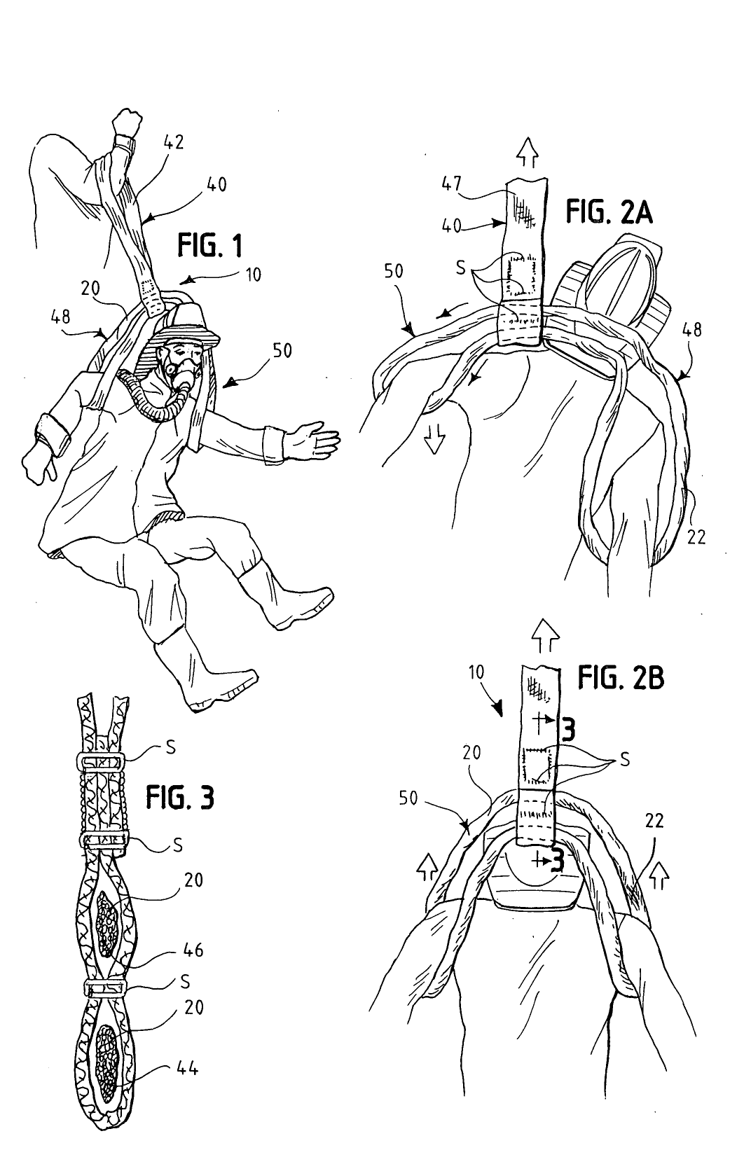

### DETAILED DESCRIPTION OF THE ILLUSTRATED EMBODIMENT

As illustrated, a drag harness 10 embodying this invention is being used by a rescuer, such as a firefighter, to drag a firefighter wearing the drag harness 10 from a perilous situation. Broadly, the drag harness 10 comprises an elongate, flexible member 20 and a drag grip 40. The elongate, flexible member 20 is joined end-to-end, via a splice 22 or a knot, so as to define a large loop. The drag grip 40 is made from a single strap, which is folded onto itself and sewn to itself, via stitches S, so as to define a drag loop 42 and so as to define tunnel-defining means defining two annular tunnels 44, 46. Rather than being sewn to itself, the drag grip 40 may be instead fastened to itself with suitable fasteners, such as rivets.

The elongate, flexible member 20 passes once through each of the annular tunnels 44, 46, so as to define two arm loops 48, 50, which have the drag grip 40 between the arm loops 48, 50. Each arm of the wearer passes through one of the arm loops 48, 50, when the drag harness 10 is worn. The elongate, flexible member 20 passes loosely through the annular tunnels 44, 46, whereby relative sizes of the arm loops 48, 50, are variable. Thus, if the wearer leans to the side where the arm loop 48 is provided, as suggested in FIG. 2A, the arm loop 48 tends to become larger, while the arm loop 50 tends to become smaller. Also, if the wearer leans to the side where the arm loop 50 is provided, the arm loop 50 tends to become larger, while the arm loop 48 becomes smaller.

Preferably, the elongate, flexible member 20 is made from a flame-resistant, non-abrading material, such as filamentary Kevlar™ rope or filamentary Nomex™ rope, or may be cotton rope or other similarly soft rope. The non-abrading material may be material, such as strapping, webbing, or rope, which has a non-abrading surface or which has a surface finish, such as a Teflon™ polytetrafluoroethylene finish or another suitable finish, which provides the material with a non-abrading surface. Herein, non-abrading means having a minimal tendency to abrade adjacent cloth, such as a cloth liner of a protective coat worn over or under the arm loops 48 of the drag harness 10.

Alternatively, the elongate, flexible member 20 is made from a flame-resistant, non-abrading material, such as Kevlar™ yarns, which are woven into flexible tubes. Rather than aramid yams, yarns of aramid blends may be alternatively used. Suitable tubes for making the elongate, flexible member 20 are available commercially from Offray Specialty Narrow Fabrics, Inc. of Chester, N.J.

Preferably, the drag grip 40 is made from a single piece of strapping, which preferably is flame-resistant, such as Kevla™ strapping or Nomex™ strapping. Alternatively, the drag grip 40 is made from a single piece of conventional strapping, such as nylon strapping or leather strapping.

1. A drag harness comprising an elongate, flexible member defining a large loop, and further comprising a drag grip provided with tunnel-defining means, through which the elongate, flexible member passes so as to divide the large loop into two arm loops having the drag grip between the arm loops.

2. The drag harness of claim 1, wherein the elongate, flexible member passes loosely through the tunnel-defining means, whereby relative sizes of the arm loops are variable.

3. The drag harness of claim 1, wherein the elongate, flexible member passes twice through the tunnel-defining means.

4. The drag harness of claim 3, wherein the elongate, flexible member passes loosely through the tunnel-defining means, whereby relative sizes of the arm loops are variable.

5. A drag harness comprising an elongate, flexible member, which defines a large loop, and a drag grip provided with a pair of tunnels, through each of which the elongate, flexible member passes so as to divide the large loop into two arm loops having the drag grip between the arm loops.

6. The drag harness of claim 5, wherein the elongate, flexible member passes loosely through the tunnel-defining means.

7. The drag harness of any preceding claim, wherein the elongate, flexible member is connected end-to-end so as to define the large loop.
